(19) United States
(12) Patent Application Publication
(10) Pub. No.: US 2007/0131285 A1
(43) Pub. Date: Jun. 14, 2007

(54) Valve means

(75) Inventors: Beate Zika-Beyerlein, Nurnberg (DE); Markus Lang, Neumarkt (DE)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: ElringKlinger AG

(21) Appl. No.: 11/634,843

(22) Filed: Dec. 7, 2006

(30) Foreign Application Priority Data
Dec. 10, 2005 (DE) 10 2005 059 120.5

(51) Int. Cl. F16K 15/03

(52) U.S. Cl. 137/512.1

(57) ABSTRACT

A valve means for blocking and clearing a passage between the pressure chambers which can be loaded with fluid pressure, especially of a passage for exhaust gas recirculation for internal combustion engines, with at least one leaf spring element (23) which is located between a valve seat surface (25) on an insert body (21) and a support surface (15) which limits the opening motion of the leaf spring element (23) away from the valve seat surface (25) to form a flutter valve, has a carrier sheet which can be inserted between the pressure chambers and which on at least one opening (11) has at least one support surface (15) as a part bent in one piece and on the respective opening (11) has a seat (17) for a second insert body (19) which bears the pertinent leaf spring element (23) and the first insert body (21) which forms the valve seat surface (25).

The invention relates to a valve means for blocking and clearing a passage between pressure chambers which can be loaded with fluid pressure, especially of a passage for exhaust gas recirculation in internal combustion engines, with at least one leaf spring element which is located between a valve seat surface on an insert body and a support surface which limits the opening motion of the leaf spring element away from the valve seat surface to form a flutter valve.

Such a valve means is known for example from EP 1 098 085 A2. If such a valve means is used to control exhaust gas recirculation in internal combustion engines by its acting as a return valve which closes at a loading pressure which exceeds the prevailing exhaust gas pressure, rapid response of the valve, that is, sudden opening and closing, is important to operation. The design of the valve means as a flutter valve meets this requirement because the leaf spring element which is used as a valve closing body has comparatively low mass inertia and thus can be quickly moved. On the other hand, flutter valves are comparatively limited with respect to the attainable opening cross section; this leads to low throughputs during the overpressure period and to pressure losses. To counteract this, valve means for these applications are conventionally made multi-flow. Disadvantageously however this leads to high production and installation effort.

In view of the foregoing, the object of the invention is to make available a valve means which meets the requirements to be imposed both with respect to the prompt response behavior and also a sufficient opening cross section, but nonetheless is characterized by an especially simple structure with correspondingly low production and installation costs.

As claimed in the invention, this object is achieved by a valve means which has features of the claim 1 in its entirety.

Accordingly, the valve means as claimed in the invention is formed from three main components, a carrier sheet with at least one opening and a first and a second insert body which can be inserted into the respective opening of the carrier sheet which for its part has support surfaces made in one piece with it in the form of bent parts. Based on this simple structure in which two insert elements each are held in one opening of the carrier without connecting means or mutual fasteners being necessary, a multi-flow construction with extremely low production and installation effort can be implemented by a corresponding number of openings in the carrier sheet being provided for identically made insert bodies. Large opening cross sections can be easily achieved by the possibility of easily implementing a multi-flow construction.

The carrier sheet can be clamped between the pressure chambers as a flat seal, and sealing beads can be made on the carrier sheet and/or on insert bodies. Advantageously therefore in a multiple function the valve means can form a seal between the bordering pressure chambers or can form a part of the seal, for example between two housing elements which are screwed to one another, of which one is part of the exhaust system and the other is part of the charging air system of an internal combustion engine.

The support surfaces on the carrier sheet can be formed such that on each opening of the carrier sheet on two parallel straight edges of the opening which are opposite one another, each respective part is bent as a support surface in the direction of the flow of the through-flowing fluid and toward one another. In this way two flutter valves can be formed on each opening, a bi-flow passage being formed between the free ends of the bent parts which are used as support surfaces for one leaf spring element at a time.

The seat for the first and second insert bodies can be provided advantageously on the edges of the openings which are for the most part rectangular in outline in the carrier sheet.

The second insert bodies, with which the leaf spring elements are made in one piece, can be thin-walled bodies with an outline which is matched to the edges of the openings of the carrier sheet which form the seat and which for their part form openings which are more or less congruent with the openings of the carrier sheet, on the two opposing edges the leaf spring elements being bent and shaped in one piece such that they extend along the respectively adjacent support surface of the carrier sheet.

The carrier sheet can be largely rectangular in advantageous embodiments and can have four identical openings configured symmetrical to one another for holding the identical first and second insertion bodies. For this purpose the carrier sheet forms the supporting base for an eight-flow flutter valve unit.

In especially advantageous embodiments the respective first insert body is made as a nozzle insert which has wall parts which extend away from an edge enclosure supported by the seat of the carrier sheet along the fluid flow and together with the respective leaf spring element which extends along the assigned support surfaces form flow guide surfaces. This yields flow optimization for the fluid flowing through, for example an exhaust gas flow, so that pressure losses due to turbulence are lower.

In this connection, the configuration can be designed such that the respective nozzle insert has wall parts which proceed from an apex area which is connected to the edge enclosure and which include an acute angle with one another such that a plane is formed which runs convergent to the respectively adjacent support surface and the wall parts between their end edge and the support surface define a gap which limits passage of the fluid. Thus, upstream from each passage there is a nozzle funnel with two converging guide surfaces so that an optimum high-speed flow is established on the passages formed on the gap.

The end edges which border the gap can form the valve seat surfaces for each respective leaf spring element which closes the gap.

The invention will be detailed below using an embodiment shown in the drawings.

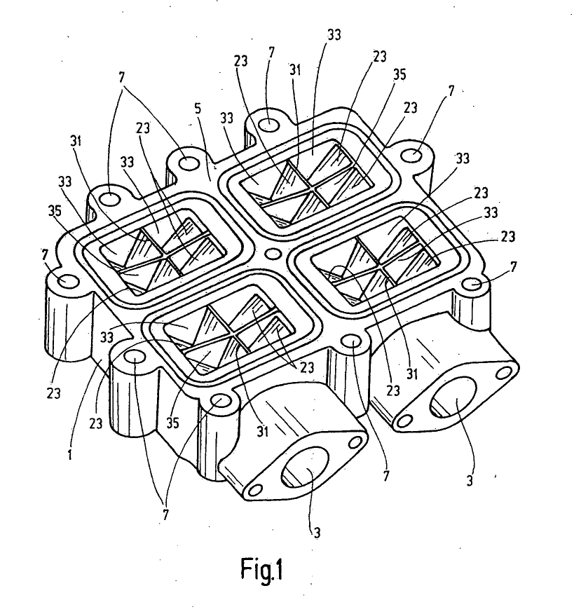

FIG. 1 shows a perspective oblique view of a housing element which is part of the charging air system of an internal combustion engine with a valve means provided on the housing opening according to one embodiment of the invention;

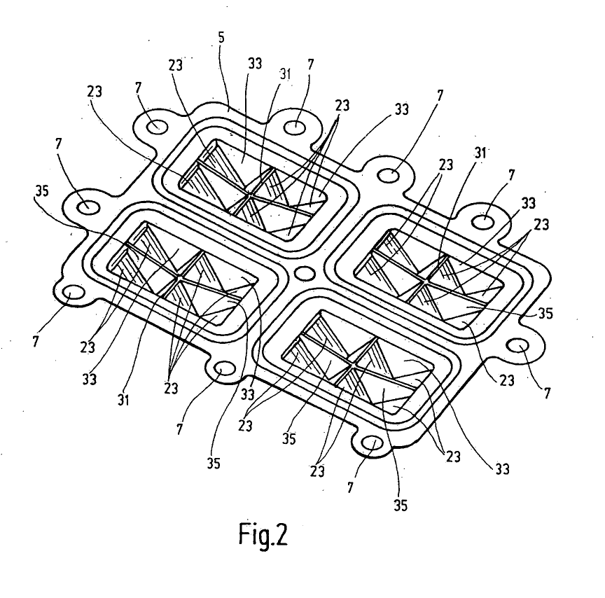

FIG. 2 shows a perspective oblique view of only one embodiment of the valve means as claimed in the invention;

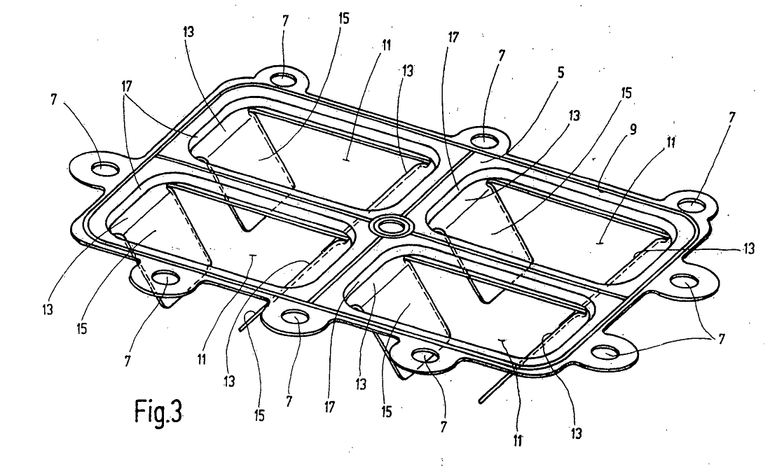

FIG. 3 shows a perspective oblique view drawn on a somewhat large scale than FIG. 2 for simply the carrier sheet of the embodiment;

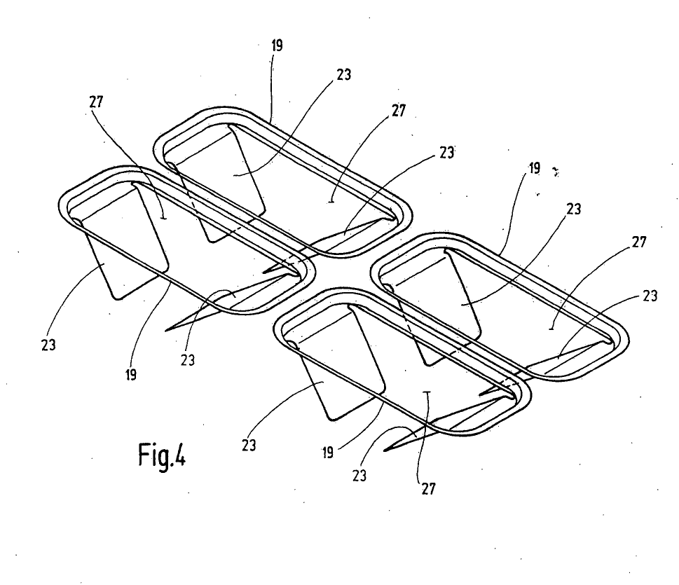

FIG. 4 shows a perspective oblique view of insert bodies which can be inserted into openings of the carrier sheet from FIG. 3, which view is drawn on a scale according to FIG. 3;

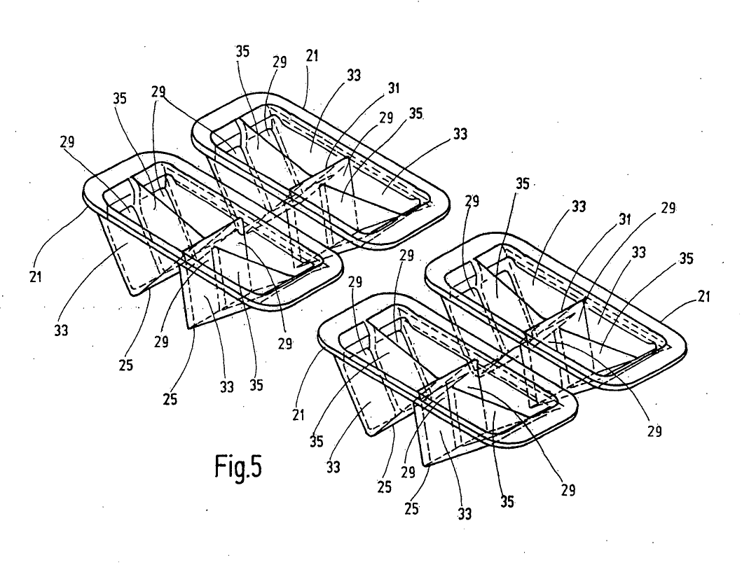

FIG. 5 shows a representation of additional insert bodies similar to FIG. 4 in the form of nozzle inserts which can be inserted together with the insert bodies from FIG. 4 into the openings of the carrier sheet from FIG. 3, and

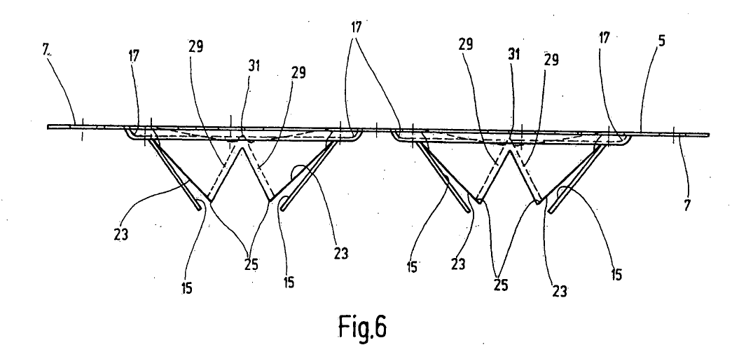

FIG. 6 shows a side view of the complete embodiment drawn on the same scale, insert bodies of two types being inserted into openings of the carrier sheet.

FIG. 1 shows a housing element 1 with an interior which forms a pressure chamber which can be connected via side housing openings 3 to the charging air system of an internal combustion engine. The upper, open side of the housing element 1 can be connected to another housing element which is not shown and which contains a further, bordering pressure chamber which is connected to the exhaust gas system of the internal combustion engine. The embodiment of the valve means as claimed in the invention shown separately in FIG. 2 is installed between the two open sides of the housing element shown in FIG. 1 and of the adjoining housing element which is not shown.

As is to be seen in FIGS. 1, 2, and 3, the valve means as the supporting main body has a carrier sheet 5 which is shown separately in FIG. 3 and which is matched with its outline to the essentially rectangular opening of the housing element 1, along the outside edges of the carrier sheet 5 which has rounded corners there being through holes 7 for passage of fastening screws (not shown) with which the exhaust gas-side housing element which is not shown can be screwed to the housing element 1 shown in FIG. 1, the carrier sheet 5 and thus the valve means being clamped between the housing elements.

As is to be seen especially clearly in FIG. 3, the carrier sheet 5 along its edges has a continuously peripheral bead 9 so that the carrier sheet 5 clamped between the housing elements as a flat seal acts as a sealing element or can contribute to sealing between the housing elements, for example in interaction with peripheral injection of a sealing material. Alternatively or in addition, sealing beads can also be formed on the components of the valve means held by the carrier sheet 5.

As is also to be seen especially clearly from FIG. 3, in the carrier sheet 5 there are four openings 11 which, except for rounded corners, are rectangular and are configured in pairs and symmetrically distributed in the carrier sheet 5. On each opening 11 on the edges 13 which are located at a distance and opposite from one another the parts are bent such that each bent part forms a support surface 15 which in this example forms with the carrier sheet 5 an angle in the range from 40° to 60°, these parts being bent in the flow direction.

Along all the side edges of the openings 11 the carrier sheet 5 forms a slightly concave seat 17 into which the insert bodies 19 and 21 which are shown separately in FIGS. 4 and 5 can be inserted. The insert bodies 10 which are shown in FIG. 4 and which are referred to as “second insert body” in the introductory part of the specification and in the claims have leaf spring elements 23 which are made in one piece with them, and which act a flutter valve closing caps. The insert bodies 21 shown in FIG. 5, referred to as “first insert body” in the introductory part of the specification and in the claims, form nozzle inserts which, as explained below, have wall parts 29 as flow guide surfaces with the end edge designated as 25 in FIG. 6 being used as the valve seat surface.

The configuration of the insert bodies 19 with the leaf spring elements 23 which are integral with them is to be seen most clearly in FIG. 4. Accordingly they are thin-walled bodies with an outline which is matched to the edges of the openings 11 of the carrier sheet 5 which form the seat 17, each insert body 19 for its part having an opening 27, from the opposing edge areas spaced apart from one another of which the leaf spring elements 23 are bent. The latter are bent in the same direction of incline as the parts of the carrier sheet 5 forming the support surfaces 15, so that when the insert bodies 19 are held in the pertinent seat 17 of the carrier sheet 5 the leaf spring elements 23 extend along the support surfaces 15.

The valve means is completed by the insert bodies 21 detailed in FIGS. 5 and 6, said insert bodies forming nozzle inserts.

FIG. 6 illustrates the installed state of the insert bodies 21, its being apparent that the wall parts 29, proceeding from the apex area 31 which extends perpendicular to the longitudinal direction of the openings 11 in the carrier sheet 5, extend tilted in the flow direction, adjacent wall parts 29 on the apex area 31 including an acute angle with one another. As is likewise apparent from FIG. 6, a gap is formed between the free end edges 25 of these wall parts 29 and the adjacent support surface 15 and forms a through opening when the pertinent leaf spring element 23 which is shown in FIG. 6 in the closed position adjoining the end edge 25 is moved away from the valve seat surface on the end edge 25 by the effect of the fluid pressure and makes contact with the support surface 15.

As is to be seen in FIGS. 1, 2, and 5, the insert bodies 21 which are made as a nozzle insert are additionally completed by side walls 33 (not all numbered in the figures) and longitudinal walls 35 which are located in the middle between them and which each form flow guide surfaces.

The invention will now be explained on the example of using the valve means to control exhaust gas recirculation in internal combustion engines. But it goes without saying that the invention can be equally used also for controlling different types of fluid flows, for example for differential pressure-dependent control of cooling water flow in a line system. For example, the valve means could be used to open and close system segments in coolant circuits of internal combustion engines controlled by the differential pressure in order to shorten the length of the warm-up phase in the desired manner. In that as claimed in the invention the base body of the valve means is a flat carrier sheet 5 which can be clamped such as a flat seal, the carrier sheet could be formed by a cylinder head gasket or part of one, and the openings which bear the insert bodies could be passages for coolant in the head gasket.

1. Valve means for blocking and clearing a passage between the pressure chambers which can be loaded with fluid pressure, especially of a passage for exhaust gas recirculation in internal combustion engines, with at least one leaf spring element (23) which is located between a valve seat surface (25) on an insert body (21) and a support surface (15) which limits the opening motion of the leaf spring element (23) away from the valve seat surface (25) to form a flutter valve, characterized in that a carrier sheet (5) which can be inserted between the pressure chambers on at least one opening (11) has at least one support surface (15) as a part bent in one piece and on the respective opening (11) has a seat (17) for a second insert body (19) which bears the pertinent leaf spring element (23) and the first insert body (21) which forms the valve seat surface (25).

2. The valve means as claimed in claim 1, wherein the carrier sheet (5) can be clamped between the pressure chambers as a flat seal, and wherein there is a sealing bead (9) which is made uninterrupted along the side edges of the carrier sheet (5) and/or there are sealing beads which are made on the edges of the insert bodies (19, 21).

3. The valve means as claimed in claim 1, wherein on each opening (11) of the carrier sheet (5) on two parallel straight edges (13) of the opening (11) which are opposite one another, one part at a time is bent as a support surface (15) in the direction of the flow of the through-flowing fluid and toward one another.

4. The valve means as claimed in claim 3, wherein the parts forming the support surface (15) are bent at an angle in the range from 40° to 60° relative to the plane of the carrier sheet (5).

5. The valve means as claimed in claim 4, wherein the seat (17) for the first (21) and second insert bodies (19) is provided on the edges of the openings (11) which are for the most part rectangular in outline in the carrier sheet (5).

6. The valve means as claimed in claim 5, wherein the second insert bodies (19) are thin-walled bodies with an outline which is matched to the edges of the openings (11) of the carrier sheet (5) which form the seat (17) and which for their part form openings (27) which are more or less congruent with the openings (11) of the carrier sheet (5), on the two opposing edges the leaf spring elements (23) being bent and shaped in one piece such that they extend along the respectively adjacent support surface (15) of the carrier sheet (5).

7. The valve means as claimed in claim 6, wherein the carrier sheet (5) is largely rectangular in advantageous embodiments and has four identical openings (11) in a configuration symmetrical to one another for holding the identical first (21) and second insert bodies (19).

8. The valve means as claimed in claim 1, wherein the respective first insert body (21) is made as a nozzle insert which has wall parts (29) which extend away from an edge enclosure supported by the seat (17) of the carrier sheet (5) along the fluid flow and together with the respective leaf spring element (23) which extends along the assigned support surfaces (15) form flow guide surfaces.

9. The valve means as claimed in claim 8, wherein the wall parts (29) proceed from an apex area (31) which is immediately adjacent to the edge enclosure and include an acute angle with one another such that a plane is formed which runs convergent to the respectively adjacent support surface (15) and the wall parts (29) between their end edge (25) and the support surface (15) define a gap which limits passage of the fluid.

10. The valve means as claimed in claim 9, wherein the end edges (25) of the wall parts (29), which edges border the gap, form the valve seat surfaces for each respective leaf spring element (23) which closes the gap.
